(19) United States
(12) Patent Application Publication
(10) Pub. No.: US 2011/0268193 A1
(43) Pub. Date: Nov. 3, 2011

(54) ENCODING AND DECODING METHOD FOR SINGLE-VIEW VIDEO OR MULTI-VIEW VIDEO AND APPARATUS THEREOF

(75) Inventors: Suk-Hee Cho, Daejon (KR); Namho Hur, Daejon (KR); Jin-Woong Kim, Daejon (KR); Soo-In Lee, Daejon (KR)

(73) Assignee: ELECTRONICS AND TELECOMMUNICATIONS RESEARCH INSTITUTE, Daejon (KR)

(21) Appl. No.: 12/681,421

(22) PCT Filed: Sep. 29, 2008
(86) PCT No.: PCT/KR2008/005739

§ 371 Date: Apr. 2, 2010

(30) Foreign Application Priority Data
Oct. 5, 2007 (KR) 10-2007-0100610

(51) Int. Cl. H04N 7/26; H04N 7/30

(52) U.S. Cl. 375/240.25; 375/240.03; 375/240.2; 375/E07.026; 375/E07.027; 375/E07.226

(57) ABSTRACT

Provided are encoding and decoding methods for a single-view video or a multi-view video and apparatuses thereof. The multi-view encoding method includes performing motion and disparity estimation based on a base image, a supplementary image, and a reference image, generating residual data using the reference image and the motion and disparity estimated data, down sampling the residual data, and transforming and quantizing the down sampled residual data using a discrete cosine transformation (DCT) method.

### TECHNICAL FIELD

The present invention relates to encoding and decoding methods and apparatuses thereof; and, more particularly, to encoding and decoding methods for a single-view video or a multi-view video and apparatuses thereof.

This work was supported by the IT R&D program of MIC/IITA [2007-S-004-01, “Development of Glassless Single-User 3D Broadcasting Technologies”].

### BACKGROUND ART

Single-view video coding is a method for encoding an image captured from one camera, and multi-view video coding (MVC) is a method for encoding images captured at the same time from a plurality of cameras disposed at different locations. The multi-view video encoding enables a user to interact with a system in order to enable the user to watch an image from a desired viewpoint. Therefore, the multi-view video encoding can support a next generation 3-D TV, a free viewpoint video, and a 3-D security system.

Effective compression has been receiving an attention in the single-view video coding and multi-view video coding.

Particularly, a multi-view video image includes a large amount of data to process, such as the number of cameras for capturing images and image sizes, compared with a typical single-view video image. Therefore, it is very important to effectively compress such a large amount of image data.

For example, terrestrial digital multimedia broadcasting (T-DMB) must provide an AV service at a limited bit rate such as 1.5 Mbps within a predetermined bandwidth. In T-DMB, each broadcasting station encodes video data at a bit rate of about 384 kbps for one AV program. Since each of the broadcasting station uses an optimized commercial encoder, an encoding method that provides a high compression rate at a low bit rate such as 5 to 600 Kbps may be more suitable to a stereoscopic DMB video coding technology, rather than an non-optimized reference SW-based encoder.

### DISCLOSURE

### Technical Problem

An embodiment of the present invention is directed to providing an encoding and decoding method for compressing data more effectively at a low bit rate.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a single-view video encoding method including performing motion estimation based on a base image and a reference image, generating residual data using blocks of the base image and the motion estimated blocks, down-sampling the residual data, and transforming the down-sampled residual data through Discrete Cosine Transformation (DCT) and quantizing the transformed residual data.

In accordance with another aspect of the present invention, there is provided a single-view video encoder including a motion estimator for performing motion estimation based on a base image and a reference image, a residual data generator for generating residual data using blocks of the base image and the motion estimated blocks, a down-sampling unit for down-sampling the residual data, and a quantizing unit for transforming the down-sampled residual data through Discrete Cosine Transformation (DCT) and quantizing the transformed residual data.

In accordance with another of the present invention, there is provided a single-view video decoding method including receiving a bit stream including base image information having residual data, up-sampling the residual data, and performing motion compensation based on a reference image and the up-sampled residual data and generating a base image.

In accordance with another aspect of the present invention, there is provided a single-view video decoder including a receiver for receiving a bit stream including base image information having residual data, an up-sampling unit for up-sampling the residual data, and a base image generator for performing motion compensation based on a reference image and the up-sampled residual data and generating a base image.

In accordance with another aspect of the present invention, there is provided a multi-view encoding method, including performing motion and disparity estimation based on a base image, a supplementary image, and a reference image, generating residual data using the reference image and the motion and disparity estimated data, down sampling the residual data, and transforming and quantizing the down sampled residual data using a discrete cosine transformation (DCT) method.

In accordance with another aspect of the present invention, there is provided a multi-view video encoder, including a motion and disparity estimator for performing motion and disparity estimation based on a base image, a supplementary image, and a reference image, a residual data generator for generating residual data using the base image and the motion and disparity estimated data, a down-sampling unit for down-sampling the residual data, and a quantizing unit for transforming the down-sampled residual data through Discrete Cosine Transformation (DCT) and quantizing the transformed residual data.

In accordance with another aspect of the present invention, there is provided a multi-view video decoding method including receiving a bit stream having base image information and supplementary image information, up-sampling the base image information, and performing motion and disparity compensation based on a reference image, the up-sampled base image information, and the supplementary image information, and generating a base image, wherein the base image information include residual data.

In accordance with another aspect of the present invention, there is provided a multi-view video decoder, including a receiver for receiving a bit stream having base image information and supplementary image information, an up-sampling unit for up-sampling the base image information, and a base image generator for performing motion and disparity compensation based on a reference image, the up-sampled base image information, and the supplementary image information, and generating a base image, wherein the base image information include residual data.

The advantages, features and aspects of the invention will become apparent from the following description of the embodiments with reference to the accompanying drawings, which is set forth hereinafter. When it is considered that detailed description on a related art may obscure a point of the present invention, the description will not be provided herein. Hereafter, specific embodiments of the present invention will be described in detail with reference to the accompanying drawings.

### Advantageous Effects

An encoding and decoding method according to the present invention can compress and restore video more effectively at a low bit rate.

### BRIEF DESCRIPTION OF THE DRAWINGS

FIG. 1 is a block diagram illustrating a single-view video encoder in accordance with an embodiment of the present invention.

FIG. 2 is a block diagram illustrating a single-view video decoder in accordance with an embodiment of the present invention.

FIG. 3 is a diagram illustrating a stereoscopic DMB video coding structure.

FIG. 4 is a block diagram illustrating a multi-view video encoder in accordance with an embodiment of the present invention.

FIGS. 5 to 7 are diagrams illustrating down-sampling in accordance with an embodiment of the present invention.

FIG. 8 is a block diagram illustrating a multi-view video decoder in accordance with an embodiment of the present invention.

FIGS. 9 to 20 show simulation results of related art and the present invention.

### BEST MODE

Hereafter, the present invention will be described by referring to the drawings.

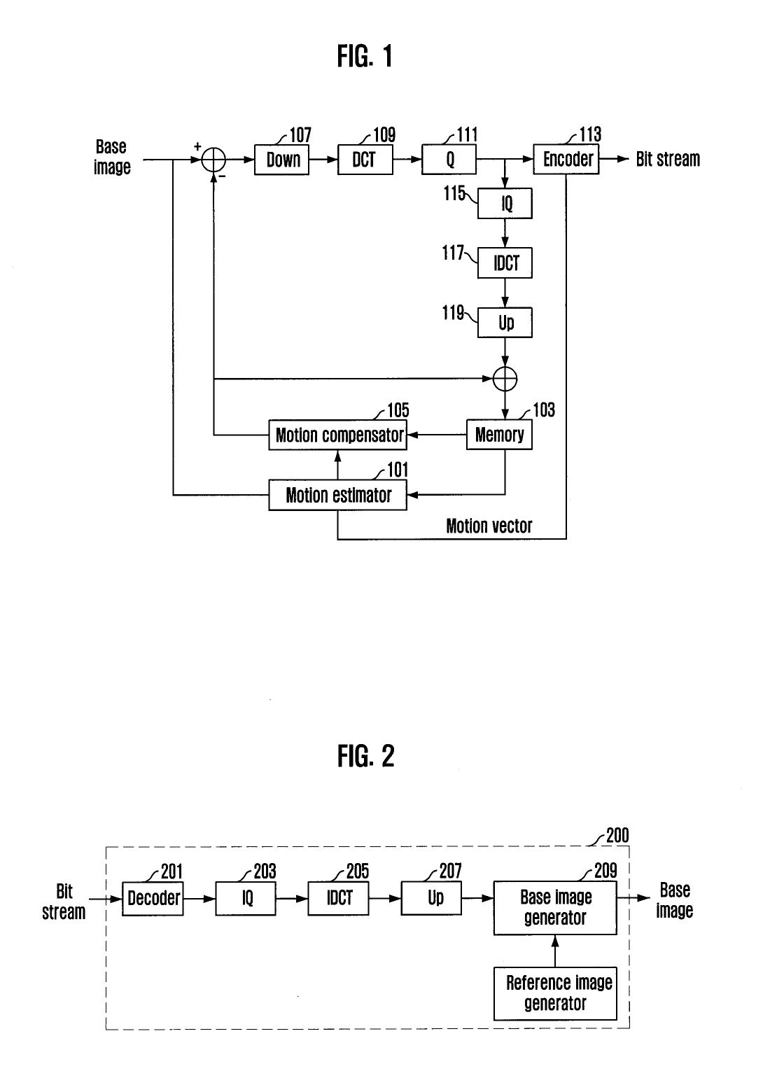

FIG. 1 is a block diagram illustrating a single-view video encoder in accordance with an embodiment of the present invention. A base image, which is a target image to encode, is inputted to a motion estimator 101. The motion estimator 101 performs a motion estimation operation using a reference image. The motion estimation operation may be performed in a unit of a macro block. A residual data generator generates residual data using a base image block and a motion estimated block. The residual data may include differential data between a block of a base image block and a motion estimation block of a reference image. A down-sampling unit 107 down-samples the residual data. A quantization unit transforms and quantizes the down-sampled residual data using a discrete cosine transformation (DCT) method. The quantization unit may include a DCT unit 109 and a quantizer 111. An encoder 113 generates a bit stream by encoding the quantized residual data. The bit stream may include information on a motion vector generated at a motion estimator 101. Here, the motion estimation operation is performed in a macro block size of a base image. That is, an amount of data to encode is reduced as much as the down-sampled amount compared with a macro block of a base image. Therefore, since the residual data to encode is reduced, data can be transmitted at a low bit rate and the deterioration of image quality can be minimized.

The down-sampling of the residual data is performed in a movement direction of an image. For example, if objects in an image make less horizontal movements, the down-sampling is performed in a horizontal direction. In this manner, the deterioration of image quality can be further minimized. The down-sampling can be performed in any one of a horizontal direction, a vertical direction, and a quarter direction according to an image. The down-sampling will be described in more detail in later.

The single-view video encoder according to the present embodiment may further include an up-sampling unit and a reference image generator for compensating motions using an up-sampled residual data and generating a reference image. The up-sampling unit may include an inverse quantizer 115 for inverse-quantizing the quantized residual data, an inverse discrete cosine transformation (IDCT) unit 117 for transforming the inverse-quantized residual data using the IDCT scheme, and an up-sampler 119 for up-sampling the transformed residual data. The motions of the reference image are compensated using the up-sampled residual data, and the motion compensated reference image may be used as a reference image for a next base image. The reference image may be stored in a memory 103. The up-sampling is used for restoring the down-sampled residual data and uses the same sampling method. Therefore, if the down-sampling is performed in the horizontal direction, the up-sampling is also performed in the horizontal direction.

FIG. 2 is a block diagram illustrating a single-view video decoder in accordance with an embodiment of the present invention. The single-view video decoder according to the present embodiment performs an inverse operation of the single-view video encoder according to the present embodiment. At first, an up-sampling unit up-samples a bit stream including a coded residual data. The up-sampling unit may include a decoder 201 for decoding a residual data, an inverse quantization unit 203 for inverse-quantizing the decoded residual data, an IDCT unit 205 for transforming the inverse quantized residual data using an IDCT scheme, and an up-sampler 207 for up-sampling the transformed residual data. The base image generator 209 performs a motion compensating operation based on a reference image and the up-sampled residual data and generates a base image. The down-sampling can be performed as any one of a horizontal down-sampling mode, a vertical down-sampling mode, and a quarter down-sampling mode according to an image. Here, since the up-sampling is performed for restoring the down-sampled residual data in the single-view video encoder, the same sampling method is used. If the residual data was down-sampled using the horizontal down-sampling mode, the up-sampling is performed in the horizontal up-sampling mode. The down-sampling will be described in detail in later.

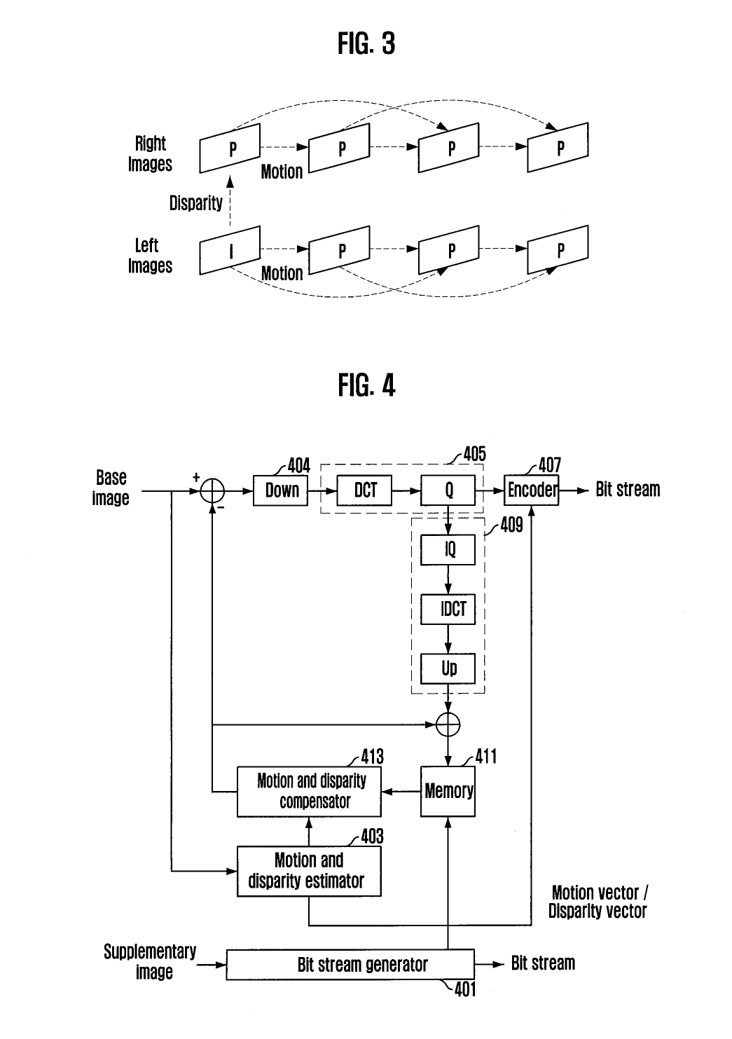

FIG. 3 is a diagram illustrating a stereoscopic DMB video coding structure. As shown, the stereoscopic DMB video coding structure uses three multiple reference pictures. When a base image, which is a base viewpoint, is encoded, a motion estimating operation is performed using three reference pictures which were previously coded at the same viewpoint. When a supplementary image, which is a supplementary viewpoint, is encoded, motion and disparity are estimated based on two reference pictures, which are previously encoded at the same viewpoint of the supplementary image, and one reference picture of the same viewpoint of the base image.

FIG. 4 is a block diagram illustrating a multi-view video encoder in accordance with an embodiment of the present invention. A supplementary image is inputted to a bit stream generator 401. The bit stream generator 401 generates a bit stream for the supplementary image. A base image, which is a target image to code, is inputted to a motion and disparity estimator 403. The motion and disparity estimator 403 performs a motion and disparity estimating operation using a supplementary image and a reference image. The motion and disparity estimating operation is performed in a unit of a macro block. A residual data generator generates a residual data using a base image block and a motion and disparity estimated block. The residual data may include differential data between the base image block and the reference image motion estimated block. A down-sampling unit 404 down-samples the residual data. A quantization unit 405 transforms and quantizes the down-sampled residual data using a discrete cosine transformation scheme (DCT). The quantization unit 405 may includes a DCT unit DCT and a quantizer Q. An encoder 407 generates a bit stream by encoding the quantized residual data. The encoder 407 may use a Context-adaptive variable-length coding (CAVLC) method. The bit stream may include information on a motion vector and a differential vector generated in the motion and disparity estimator 403. Here, the motion and disparity estimating operation is performed in a macro block size of a base image. That is, an amount of data to encode is reduced as much as a down-sampled amount compared with a macro block of a base image. Therefore, since the residual data to encode is reduced, the encoded residual data can be transmitted at a low bit rate, and the deterioration of the image quality can be minimized.

The down-sampling of the residual data is performed in a movement direction of an image. For example, if objects in an image make less horizontal movements, the down-sampling is performed in a horizontal direction. In this manner, the deterioration of image quality can be further minimized. The down-sampling can be performed as any one of a horizontal down-sampling mode, a vertical down-sampling mode, and a quarter down-sampling mode according to an image. The down-sampling will be described in more detail in later.

The multi-view video encoder according to the present embodiment further includes an up-sampling unit 409 and a reference image generator for compensating motions and differences using the up sampled residual data and generating a reference image. The up sampling unit 409 includes an inverse quantization unit IQ for inverse quantizing the quantized residual data, an Inverse Discrete Cosine Transformation unit IDCT for transforming the inverse-quantized residual data using the IDCT scheme, and an up-sampler for up-sampling the transformed residual data. The motion of the reference image is compensated using the up-sampled residual data. The motion compensated reference image may be used as a reference image for a next base image to encode. The supplementary images and the reference image may be stored in a memory 411. Since the up-sampling is performed for restoring the down-sampled residual data, the same sampling method is used. Therefore, if the down sampling was performed in a horizontal direction, the up sampling is also performed in the horizontal direction.

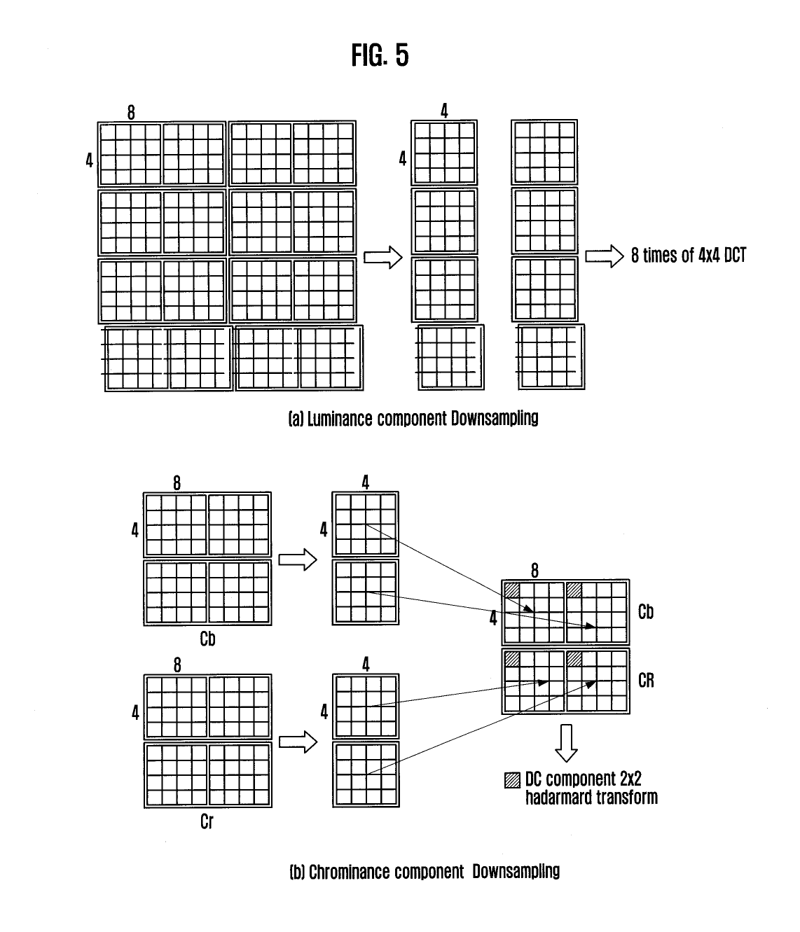

FIGS. 5 to 7 are diagrams illustrating down sampling in accordance with an embodiment of the present invention. The residual data may be down-sampled using following three sampling methods when a macro block of a base image to encode is Inter 16×16, 8×16, 16×8, and 8×8 Modes.

(1) Horizontal Down-sampling Mode: ½ down sampling in a horizontal direction

(2) Vertical Down-sampling Mode: ½ down sampling in a vertical direction

(3) Quarter Down-sampling Mode: ½ down sampling in both of a horizontal direction and a vertical direction

Objects make motions in a horizontal director or a vertical direction according to images or contents. Therefore, any one of the horizontal, vertical, and quarter down-sampling modes is applied according to a movement direction of an object included in images or contents. For example, the horizontal down-sampling mode is performed for an image or content including an object makes less motion in a horizontal direction. In this manner, an amount of bits to encode can be reduced, and the deterioration of image quality can be minimized.

In case of a stereoscopic DMB video, in case of a monitor for displaying an image at a 320×240 resolution with a 3D display scheme, and a monitor for displaying images by interlacing images in a horizontal direction, the deterioration of image quality in a horizontal direction can be prevented by performing a horizontal down-sampling mode because the monitor displays data with a horizontal resolution reduced by ½. In case of a monitor displaying images by interlacing the images in a vertical direction, the deterioration of image quality in the horizontal direction can be prevented by performing the vertical down sampling operation because the monitor displays data with a vertical resolution reduced by ½.

The down sampling mode according to the present embodiment can be applied for four inter estimation modes 16×16, 8×16, 16×8, and 8×8 among inter estimation modes of joint multi-view video model (JMVM) in an estimation mode with down sampling applied to residual data. Therefore, the multi-view video encoding method according to the present embodiment perform 16 times of 4×4 DCT and quantization by dividing each macro block into 16 blocks of 4×4 pixels for luminance components. 8 times or 4 times of 4×4 DCT and quantization are performed in the present embodiment by down-sampling the residual data as shown in FIGS. 5 to 7. Here, the down sampling uses a three tap filter [coefficient: (1,2,1)/4], and the up sampling uses a six tap filter (Finite Impulse Response) [coefficient:(1, −5, 20, 20, −5, 1)/32], which is used in an advanced video coding (AVC).

FIG. 5 is a diagram illustrating an encoding method by horizontal down sampling residual data in accordance with an embodiment of the present invention. As shown in FIG. 5, residual data is divided into 8 blocks of 8×4 pixels for luminance component Y, and the 8 blocks of 8×4 pixels are down-sampled to eight 4×4 pixel blocks. Then, the DCT and the quantizing operation are performed for the eight 4×4 pixel blocks. The residual data is divided into two blocks of 8×4 pixels for chrominance components Cb and Cr, and the two blocks are down sampled to 4×4 pixel blocks. Two 4×4 pixel blocks for each of chrominance components Cb and Cr are arranged as shown in FIG. 5, 2×2 Hadamard transform is performed for four DC components, and each of the 4×4 pixel blocks are transformed through DCT and quantized.

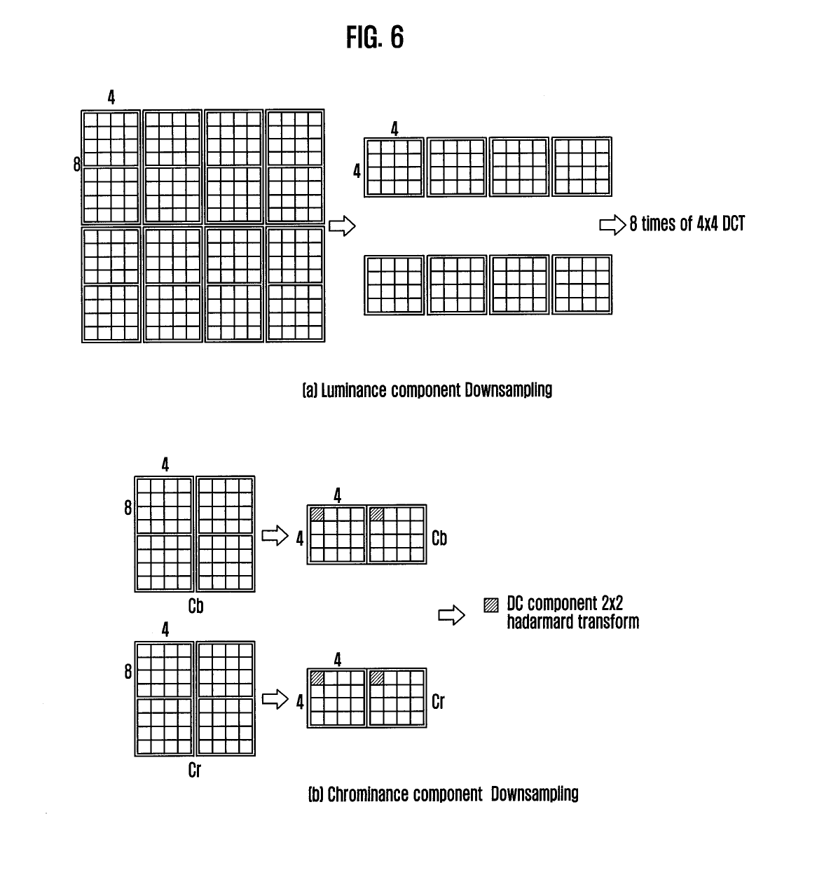

FIG. 6 is a diagram illustrating an encoding method by performing a vertical down sampling on residual data in accordance with an embodiment of the present invention. As shown in FIG. 6, the residual data is divided into eight 4×8 pixel blocks for luminance component Y, and the eight 4×8 pixel blocks are down sampled to 4×4 pixel blocks. The down-sampled eight 4×4 pixel blocks are transformed through DCT and quantized. For chrominance components Cb and Cr, the residual data is divided into two 4×8 pixel blocks, and the two 4×8 pixel blocks are down sampled to 4×4 pixel blocks. Two 4×4 pixel blocks of each chrominance component Cb and Cr are arranged as shown in FIG. 4. Then, 2×2 Hadamard transform is performed for four DC components, and each of the blocks is transformed through DCT and quantized.

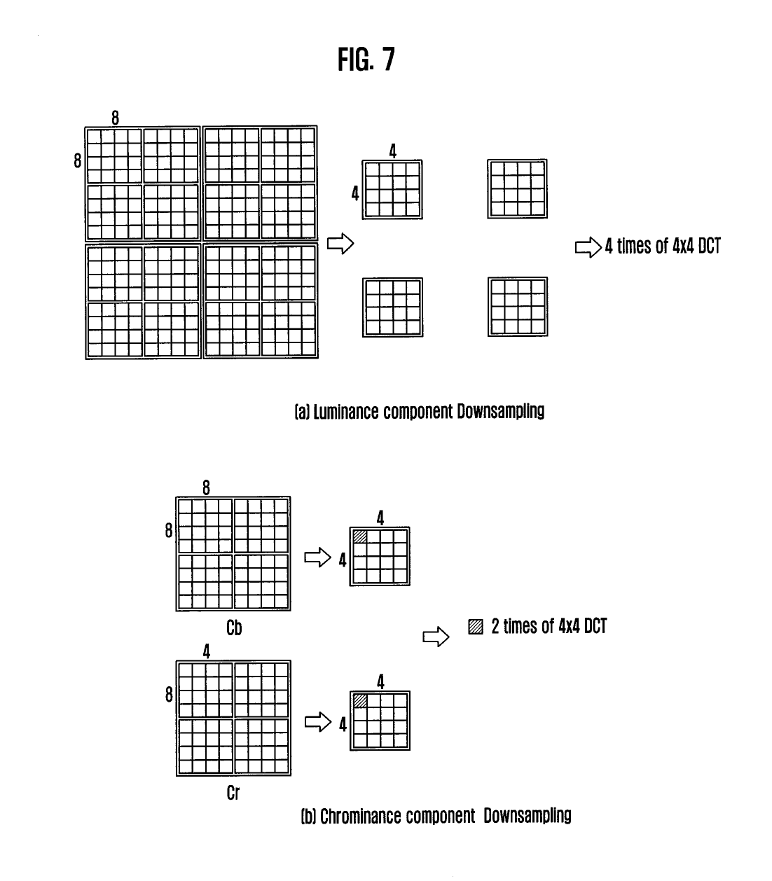

FIG. 7 is a diagram illustrating an encoding method by performing a quarter down sampling on residual data in accordance with an embodiment of the present invention. As shown in FIG. 7, residual data is divided into four 8×8 pixel blocks for luminance component Y, and the four 8×8 pixel blocks are down sampled to 4×4 pixel blocks. The down sampled four 4×4 pixel blocks are transformed through DCT and quantized. For chrominance components Cb and Cr, the residual data is divided into one 8×8 pixel block, and the 8×8 pixel block is down sampled to 4×4 pixel blocks. Each of the 4×4 pixel blocks is transformed through DCT and quantized.

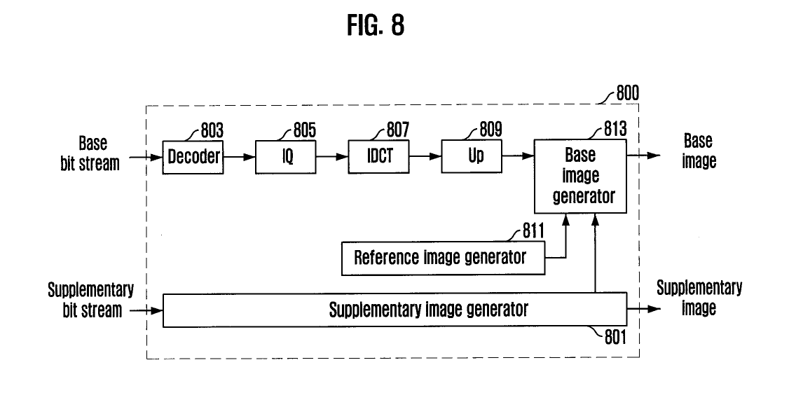

FIG. 8 is a block diagram illustrating a multi-view video decoder in accordance with an embodiment of the present invention. The multi-view video decoder according to the present embodiment performs inverse operation of the multi-view video encoder according to the present embodiment. At first, a supplementary image generator 801 receives a supplementary bit stream including information on a supplementary image and generates the supplementary image. The supplementary image generator 801 may use an AVC H.264 method. An up-sampling unit receives a base bit stratum including residual data for a base image and up-samples the residual data. The up-sampling unit includes a decoder 801 for decoding the residual data, an inverse quantization unit 805 for inverse quantizing the decoded residual data, an IDCT unit 807 for transforming the inverse-quantized residual data through IDCT, and an up-sampler 809 for up-sampling the transformed residual data. A base image generator 813 generates a base image by performing motion and disparity compensation based on a reference image, a supplementary image, and the up-sampled residual data. The down-sampling of the residual data is performed in a movement direction of an image. The down-sampling can be performed in any one of a horizontal direction, a vertical direction, and a quarter direction according to an image. Here, since the up-sampling is performed for restoring the down-sampled residual data in the multi-view video encoder, the multi vie video decoder uses the same sampling method. If the residual data was down-sampled through a horizontal down-sampling mode, the up sampling is performed through a horizontal up-sampling mode.

Meanwhile, a De-blocking Filter may employ a De-blocking algorithm used in AVC. However, an indexing part may be modified not to refer blocks that are not encoded by down-sampling the residual data.

Syntax for embodying a method for down-sampling residual data according to the present embodiment may add information (residual_dowmsampling_mode) on a down sampling mode for residual data of the present invention to sequence_paprameter_mvc_extension( )

sequence_paprameter_mvc_extension( )
{
num_views_minus_1
for (i=0; i<=num_views_minus_1;i++){
residual_dowmsampling_mode[i]
}
}

Here, the information residual_dowmsampling_mode may include information of Table 1 with H.7.4.1 “sequence parameter set MVC extension semantics”.

TABLE 1

| Value | Mode |
|---|---|
| 00 | Non_residual_downsampling |
| 01 | Horizontal_residual_downsampling |
| 10 | Vertical_residual_downsampling |
| 11 | Quarter_residual_downsampling |

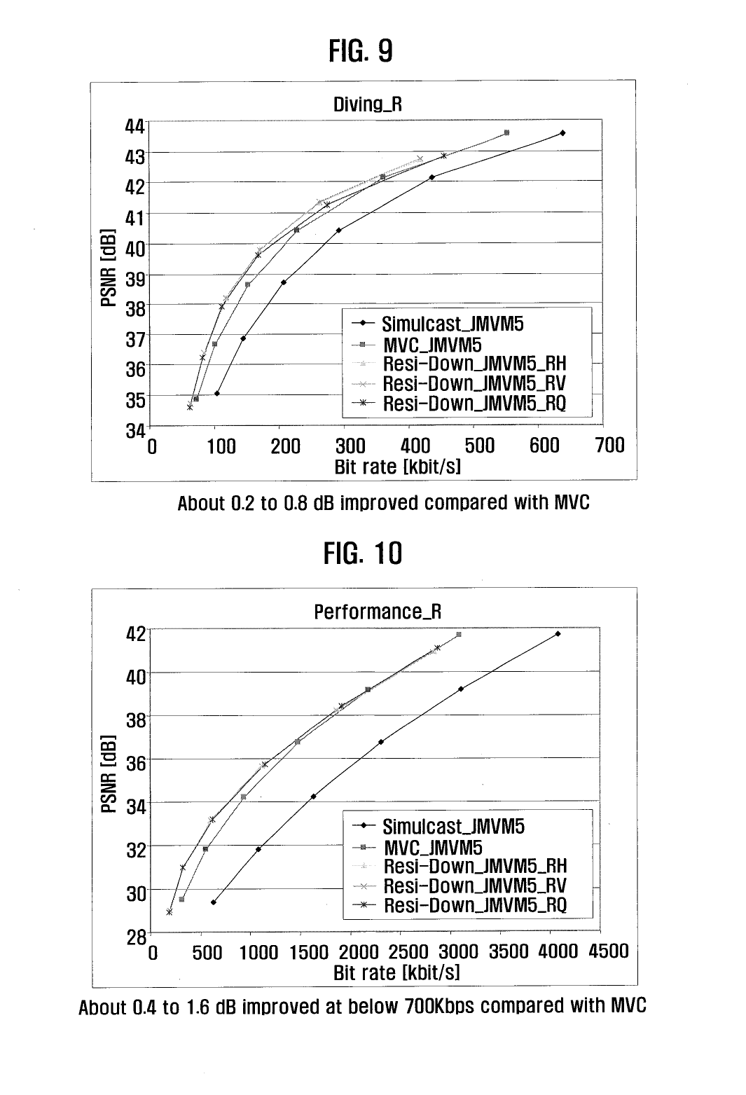

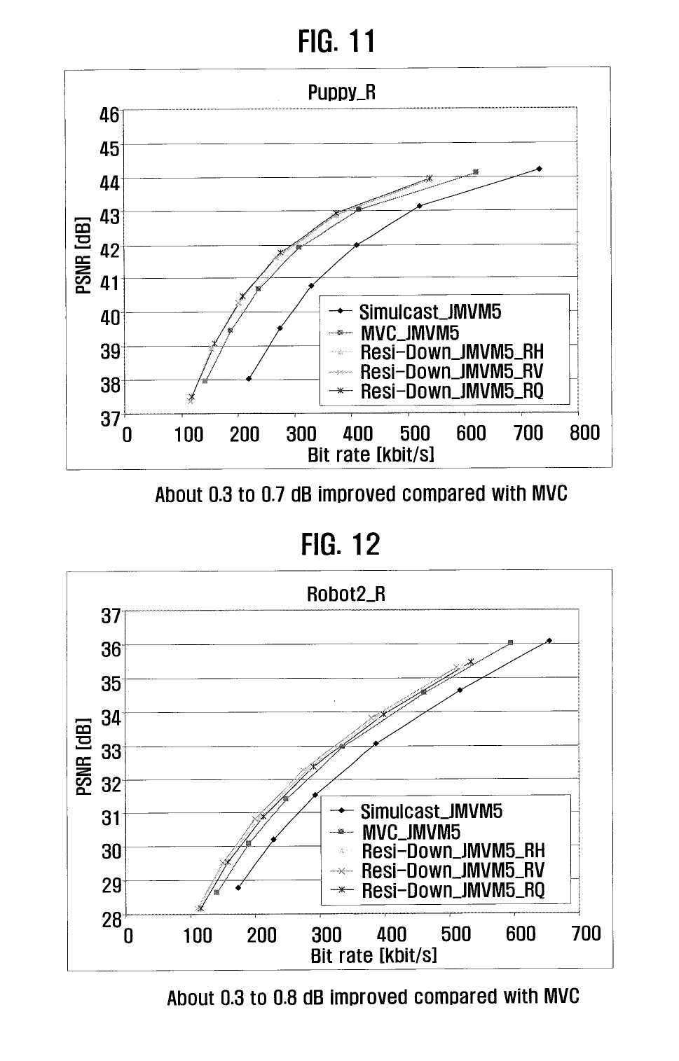

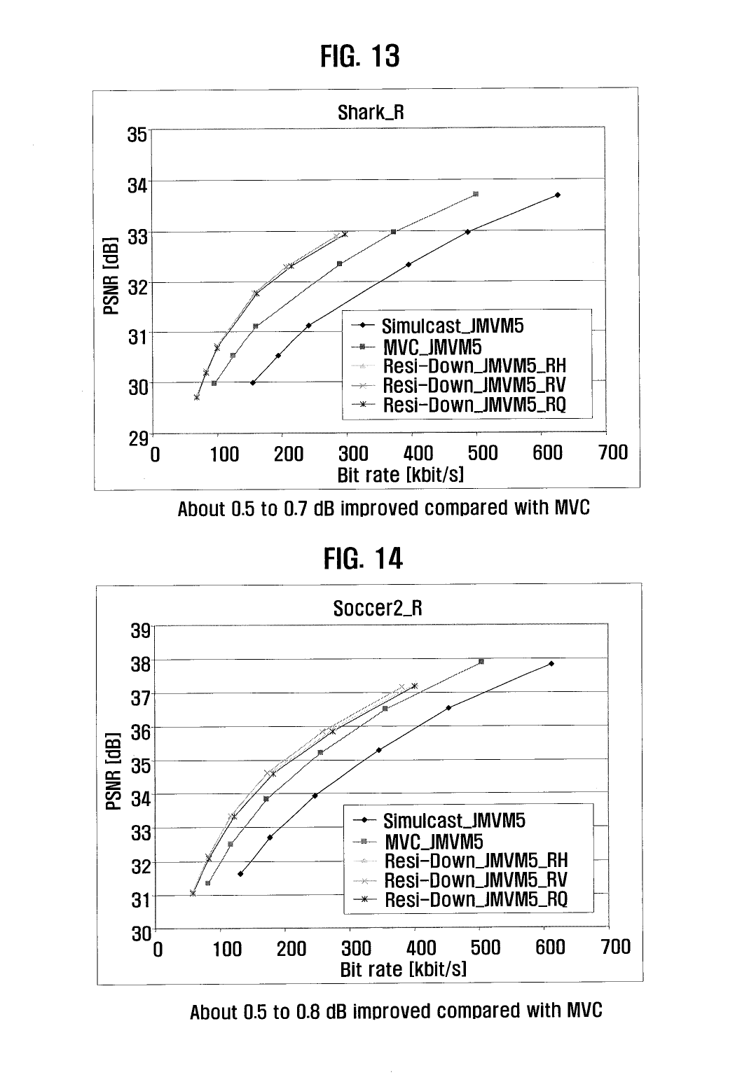

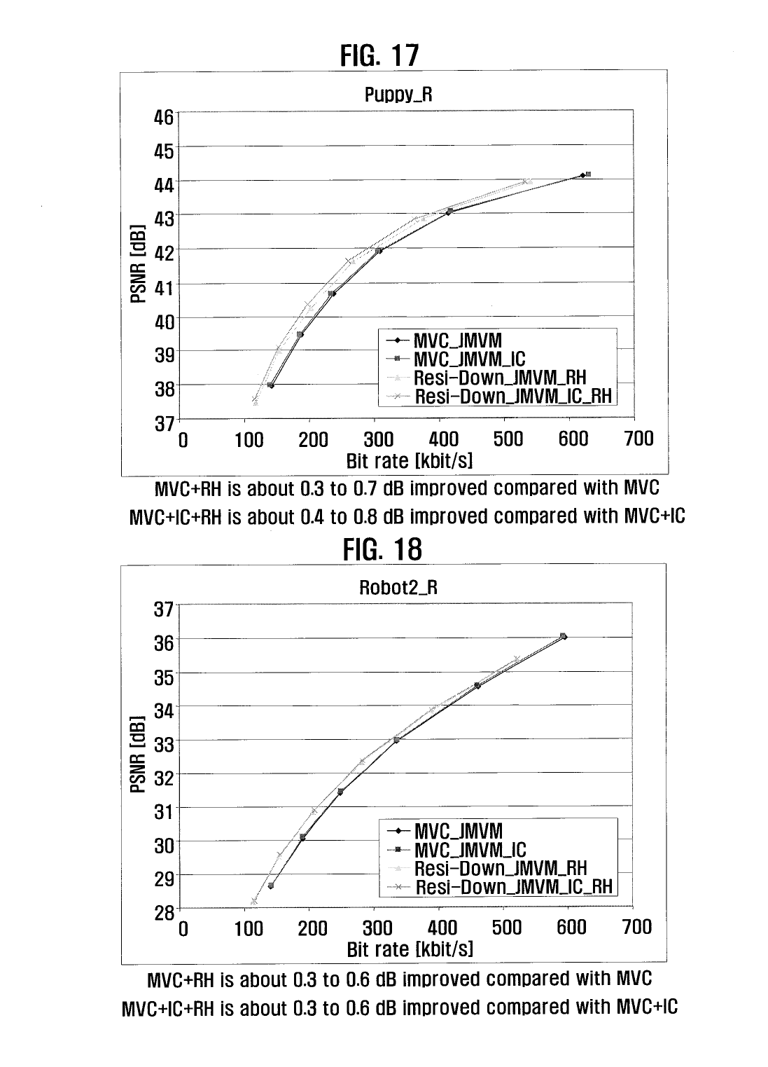

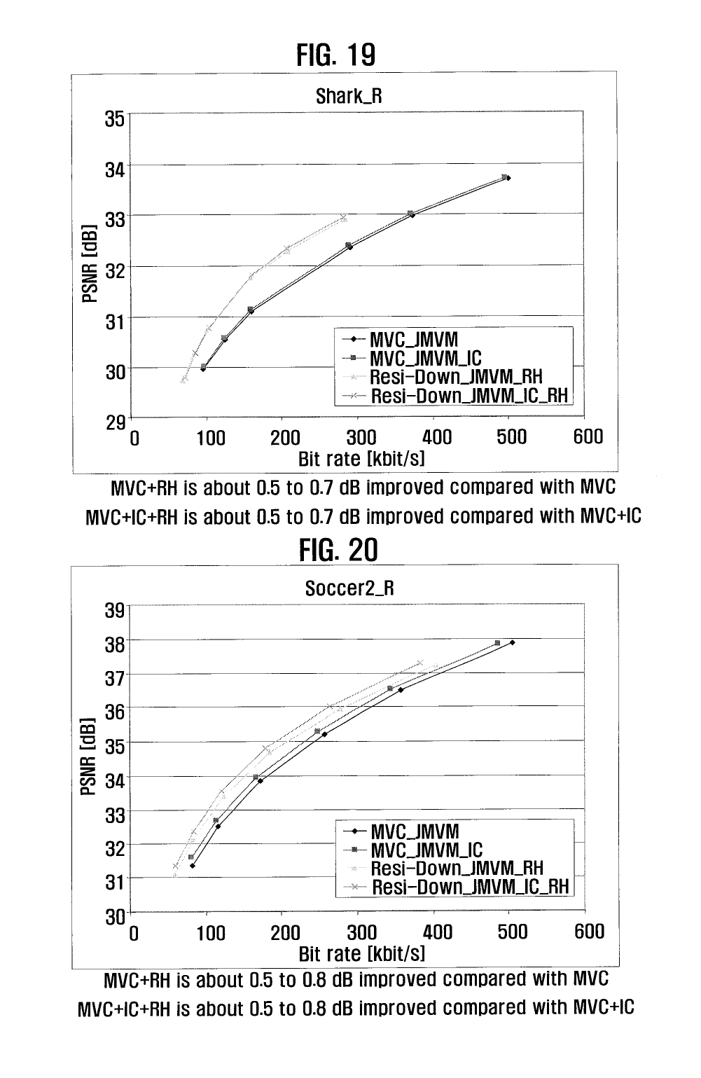

FIGS. 9 to 20 show simulation results of related art and the present invention.

Graphs of FIGS. 9 to 14 show a simulation result of down sampling residual data for a right image according to the present embodiment compared with related art Simulcase_JMVM and MVC_JMVM. In graphs, an X axis denotes a bit rate kbit/s, and a Y axis denotes a peak signal-to-noise ratio (PSNR). The graphs of FIGS. 9 to 14 show results of simulations with different images. Here, RH denotes ½ reduction in a horizontal direction, RV denotes ½ reduction in a vertical direction, and RQ denotes ½ reduction in a horizontal direction and a vertical direction. As shown in FIGS. 9 to 14, the simulation results clearly show the present invention provides about 0.1 to 1.2 dB better than MVC in average.

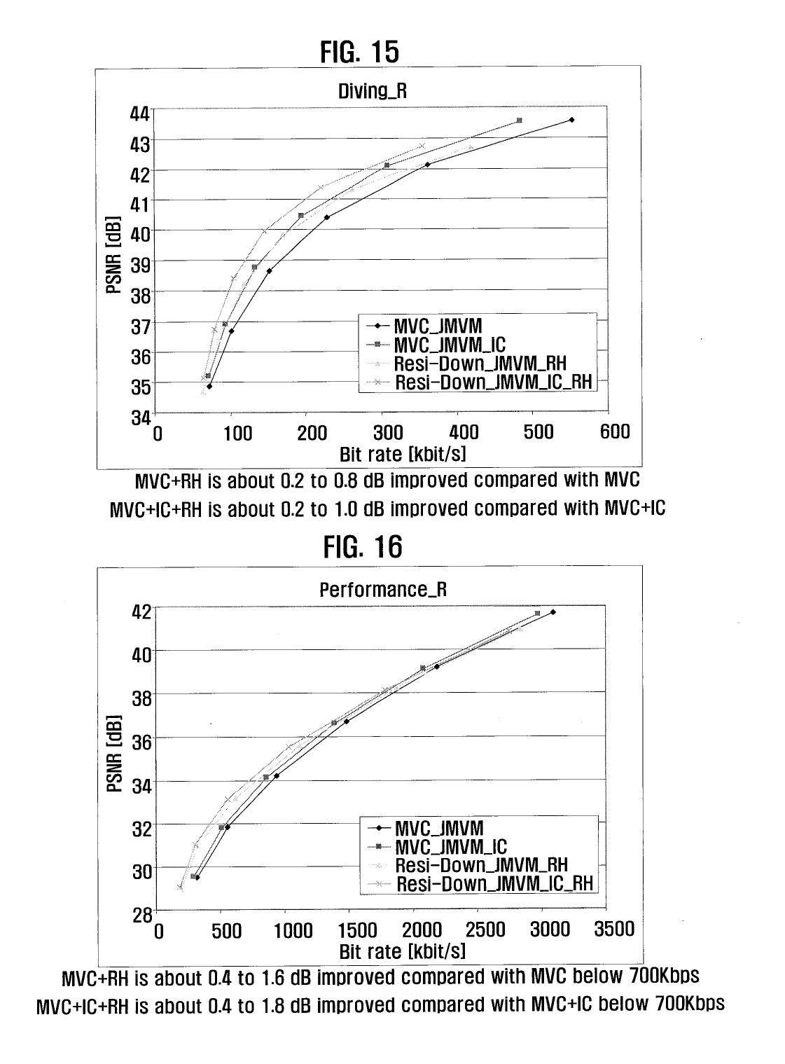

Graphs of FIGS. 15 to 20 show a simulation result of down sampling residual data for a right image according to the present embodiment compared with related art MVC_JMVM and MVC_JMVM_IC. In graphs, an X axis denotes a bit rate kbit/s, and a Y axis denotes a peak signal-to-noise ratio (PSNR). The graphs of FIGS. 15 to 20 show results of simulations with different images. The graphs compares a simulation result of related art MVC with illumination compensation (IC) turned-on with a simulation result of the present invention that encodes data with ½ reduction in a horizontal direction and IC turned on. The graphs clearly show that the present invention provides about 0.1 to 1.6 dB better performance than the related art MVC. The graphs show the similar result for the RV method that reduces data to encode by in a vertical direction and the RQ method that reduces data to encode by ½ in a vertical direction and a horizontal direction.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

### Mode for the Invention

Following description exemplifies only the principles of the present invention. Even if they are not described or illustrated clearly in the present specification, any one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like.

To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is determined to obscure the point of the present invention, the description is omitted. Hereafter, preferred embodiments of the present invention will be described in detail with reference to the drawings.

The present invention reduces the number of blocks to encode by down-sampling residual data. Therefore, the deterioration of image quality can be minimized and video data can be compressed more effectively at a low bit rate. The present invention can be applied not only to a single-view video but also to a multi-view video.

Single-view video coding is a method for encoding an image captured from one viewpoint, and multi-view video coding is a method for encoding images captured at the same time from more than two viewpoints, which are disposed at different spatial locations. Although the single-view video encoding and the multi-view video encoding use a similar encoding method, the multi-view video encoding uses a disparity vector DV with a motion vector unlike the single-view that uses a motion vector (MV) only. The motion vector denotes motion information of an object in an image captured from one camera, and the disparity vector denotes a location difference of an object among images captured from different cameras. Hereinafter, the single-view video encoding method and the multi-view video encoding method will be described in detail.

In case of the single-view video, motion estimation is performed for a base image using a reference image. The reference image is an image compared with the base image. For example, the reference image may be an image previously encoded. Residual data is generated using the motion-estimated blocks of the reference image and blocks of the base image, and the number of blocks to encode is reduced by down-sampling the generated residual data. The down-sampled residual data is encoded by transforming and quantizing the down-sampled residual data through discrete cosine transformation (DCT).

Meanwhile, the quantized residual data is inverse quantized, transformed through inverse discrete cosine transformation (IDCT), and up-sampled. Using the up-sampled residual data, motion compensation is performed, and a motion-compensated image is generated. The motion compensated image may be used as a reference image for a next image to encode. Here, the down sampling may be performed according to a movement rate of an image. The movement rate includes a movement direction of an object included in an image. The down sampling may use three methods, a horizontal down-sampling mode for down-sampling data in a horizontal direction, a vertical down-sampling mode for down-sampling data in a vertical direction, and a quarter down-sampling mode for down-sampling data in a horizontal direction and a vertical direction. For example, in case of contents having less horizontal movements, the horizontal down-sampling is performed for reducing an amount of bits while minimizing the deterioration of image quality. Here, the down sampling and the up sampling use the same sampling method. For example, if the down sampling is performed as a horizontal down sampling mode, the up sampling is also performed as a horizontal down sampling mode.

Decoding of the coded signal view video performs the encoding steps of the single-view video are performed in a reverse order. That is, a base image can be restored by decoding the down-sampled and encoded data, up-sampling the decoded data, performing motion compensation. Here, the down sampling and the up sampling use the same sampling method. For example, the down sampling is performed as a horizontal down sampling mode, the up sampling is also performed as a horizontal down sampling mode.

In case of the multi-view video, motion and disparity estimation is performed for a base image using a supplementary image and a reference image. For example, motion estimation is performed using the base image and a reference image, and disparity estimation is performed using the base image and the supplementary image. Here, the base image and the supplementary image are images of different viewpoints. For example, in case of two viewpoints captured from a left side and a right side, the base image and the supplementary image may be a left image and a right image or vice versa. The reference image is an image compared with the base image. For example, the reference image may be an image encoded at a previous stage. Residual data is generated using estimated blocks of the supplementary image and the reference image and blocks of the base image, and the number of blocks to encode is reduced by down sampling the generated residual data. The down-sampled residual data is encoded by transforming and quantizing the down-sampled residual data through discrete cosine transformation (DCT).

Meanwhile, the quantized residual data is inverse quantized, transformed through the inverse discrete cosine transformation (IDCT), and up-sampled. The motion and disparity compensation is performed using the up-sampled residual data. The motion compensated image may be used as a reference image for a next image to encode. Here, the down sampling may be performed according to the movement rate of an image. The movement rate includes a movement direction of an object included in an image. The down sampling may use three methods, a horizontal down-sampling mode for down-sampling data in a horizontal direction, a vertical down-sampling mode for down-sampling data in a vertical direction, and a quarter down-sampling mode for down-sampling data in a horizontal direction and a vertical direction. For example, in case of contents having less horizontal movements, the horizontal down-sampling is performed for reducing an amount of bits while minimizing the deterioration of image quality. Here, the down sampling and the up sampling use the same sampling method. For example, if the down sampling is performed as a horizontal down sampling mode, the up sampling is also performed as a horizontal down sampling mode.

Decoding of coded multi-view video is performed the encoding steps of the multi-view video in a reverse order. That is, a base image may be restored by decoding the down-sampled and encoded data, up-sampling the decoded data, performing motion and disparity compensation. Here, the down sampling and the up sampling uses the same sampling method. For example, if the down sampling is performed as a horizontal down sampling mode, the up sampling is also performed as a horizontal down sampling mode.

Hereinafter, the single-view video coding and the multi-view video coding will be described in detail with embodiments.

<Single-View Video Coding>

A single-view video encoding method according to an embodiment of the present invention includes performing motion estimation based on a base image and a reference image, generating residual data using blocks of the base image and the motion estimated blocks, down-sampling the residual data, and transforming the down-sampled residual data through Discrete Cosine Transformation (DCT) and quantizing the transformed residual data.

The single-view video encoding method may further include inverse-quantizing the quantized residual data and transforming the inverse-quantized residual data through Inverse Discrete. Cosine Transformation (IDCT), and up-sampling the transformed residual data, and performing motion compensation using the up-sampled residual data and generating a reference image. The motion estimation may be performed in a macro block size of the base image. The residual data may be down-sampled along a movement direction of an image. For example, the residual data may be down-sampled using any one of a horizontal down-sampling mode, a vertical down-sampling mode, and a quarter down-sampling mode.

A single-view video encoder according to an embodiment of the present invention includes a motion estimator for performing motion estimation based on a base image and a reference image, a residual data generator for generating residual data using blocks of the base image and the motion estimated blocks, a down-sampling unit for down-sampling the residual data, and a quantizing unit for transforming the down-sampled residual data through Discrete Cosine Transformation (DCT) and quantizing the transformed residual data.

The single-view video encoder may further include an up-sampling unit for inverse-quantizing the quantized residual data and transforming the inverse-quantized residual data through Inverse Discrete Cosine Transformation (IDCT), and up-sampling the transformed residual data, and a reference image generator for performing motion compensation using the up-sampled residual data and generating a reference image. The motion estimation may be performed in a macro block size of the base image. The residual data may be down-sampled along a movement, direction of an image. For example, the residual data may be down-sampled using any one of a horizontal down-sampling mode, a vertical down-sampling mode, and a quarter down-sampling mode.

<Single-View Video Decoding>

A single-view video decoding method according to an embodiment of the present invention includes receiving a bit stream including base image information having residual data, up-sampling the residual data, and performing motion compensation based on a reference image and the up-sampled residual data and generating a base image. The up-sampling the residual data may include decoding the residual data, inverse-quantizing the decoded residual data, and transforming the inverse-quantized residual data through Inverse Discrete Cosine Transformation (IDCT). The residual data may be up-sampled along a movement direction of an image. For example, the residual data may be up-sampled using any one of a horizontal up-sampling mode, a vertical up-sampling mode, and a quarter up-sampling mode.

A single-view video decoder according to an embodiment of the present invention includes a receiver for receiving a bit stream including base image information having residual data, an up-sampling unit for up-sampling the residual data, and a base image generator for performing motion compensation based on a reference image and the up-sampled residual data and generating a base image. The up-sampling unit may include a decoder for decoding the residual data, an inverse-quantizing unit for inverse-quantizing the decoded residual data, and an inverse discrete cosine transform (IDCT) unit for transforming the inverse-quantized residual data through IDCT. The residual data may be up-sampled along a movement direction of an image. For example, the residual data may be up-sampled using any one of a horizontal up-sampling mode, a vertical up-sampling mode, and a quarter up-sampling mode.

<Multi-View Video Encoding>

A multi-view encoding method according to an embodiment of the present invention includes performing motion and disparity estimation based on a base image, a supplementary image, and a reference image, generating residual data using the reference image and the motion and disparity estimated data, down sampling the residual data, and transforming and quantizing the down sampled residual data using a discrete cosine transformation (DCT) method.

The multi-view encoding method may further include inverse-quantizing the quantized residual data, transforming the inverse-quantized residual data through inverse discrete cosine transformation (IDCT), and up-sampling the transformed residual data, and performing motion and parity compensation using the up-sampled residual data and generating a reference image. The motion and disparity estimation may be performed in a macro block size of the base image. The residual data may be down-sampled in a movement direction of an image. For example, the residual data is down-sampled using any one of a horizontal down-sampling mode, a vertical down-sampling mode, and a quarter down-sampling mode.

A multi-view video encoder according to an embodiment of the present invention includes a motion and disparity estimator for performing motion and disparity estimation based on a base image, a supplementary image, and a reference image, a residual data generator for generating residual data using the base image and the motion and disparity estimated data, a down-sampling unit for down-sampling the residual data, and a quantizing unit for transforming the down-sampled residual data through Discrete Cosine Transformation (DCT) and quantizing the transformed residual data.

The multi-view video encoder may further include an up-sampling unit for inverse-quantizing the quantized residual data, transforming the inverse-quantized residual data through Inverse Discrete Cosine Transformation (IDCT), and up-sampling the transformed residual data, and a reference image generator for performing motion and disparity compensation using the up-sampled residual data and generating a reference image. The motion and disparity estimation may be performed in a macro block size of the base image. The residual data may be down-sampled along a movement direction of an image. For example, the residual data is down-sampled using any one of a horizontal down sampling mode, a vertical down sampling mode, and a quarter down sampling mode.

<Multi-View Video Decoding>

A multi-view video decoding method according to an embodiment of the present invention includes receiving a bit stream having base image information and supplementary image information, up-sampling the base image information, and performing motion and disparity compensation based on a reference image, the up-sampled base image information, and the supplementary image information, and generating a base image. The base image information includes residual data. The up-sampling the base image information may include decoding the base image information, inverse-quantizing the decoded base image information, and transforming the inverse-quantized base image information through inverse discrete cosine transform (IDCT). The residual data may be up-sampled along a movement direction of an image. For example, the residual data is up-sampled using any one of a horizontal up-sampling mode, a vertical up-sampling mode, and a quarter up-sampling mode.

A multi-view video decoder according to an embodiment of the present invention includes a receiver for receiving a bit stream having base image information and supplementary image information, an up-sampling unit for up-sampling the base image information, and a base image generator for performing motion and disparity compensation based on a reference image, the up-sampled base image information, and the supplementary image information, and generating a base image. The base image information may include residual data. The up-sampling unit may include a decoder for decoding the base image information, an inverse quantizer for inverse-quantizing the decoded base image information, and an inverse discrete cosine transform (IDCT) unit for transforming the inverse-quantized base image information through IDCT. The up-sampling unit up-samples the residual data along a movement direction of an image. For example, the up-sampling unit up-samples the residual data using any one of a horizontal up-sampling mode, a vertical up-sampling mode, and a quarter up-sampling mode.

### INDUSTRIAL APPLICABILITY

The present invention is applied to single-view video encoding and decoding and multi-view video encoding and decoding for compressing data more effectively at a low bit rate.

1. A multi-view encoding method, comprising:
performing motion and disparity estimation based on a base image, a supplementary image, and a reference image;
generating residual data by using the reference image and the motion and disparity estimated data;
down sampling the residual data; and
transforming and quantizing the down sampled residual data using a discrete cosine transformation (DCT) method.

2. The multi-view encoding method of claim 1, further comprising:
inverse-quantizing the quantized residual data, transforming the inverse-quantized residual data through inverse discrete cosine transformation (IDCT), and up-sampling the transformed residual data; and
performing motion and parity compensation using the up-sampled residual data and generating a reference image.

3. (canceled)

4. The multi-view encoding method of claim 1, wherein in said down sampling the residual data,
the residual data is down-sampled in a movement direction of an image.

5. The multi-view encoding method of claim 1, wherein in said down sampling the residual data,
the residual data is down-sampled using any one of a horizontal down-sampling mode, a vertical down-sampling mode, and a quarter down-sampling mode.

6. A multi-view video encoder, comprising:
a motion and disparity estimator for performing motion and disparity estimation based on a base image, a supplementary image, and a reference image;
a residual data generator for generating residual data using the base image and the motion and disparity estimated data;
a down-sampling unit for down-sampling the residual data; and
a quantizing unit for transforming the down-sampled residual data through Discrete Cosine Transformation (DCT) and quantizing the transformed residual data.

7-10. (canceled)

11. A multi-view video decoding method, comprising:
receiving a bit stream having base image information and supplementary image information;
up-sampling the base image information; and
performing motion and disparity compensation based on a reference image, the up-sampled base image information, and the supplementary image information, and generating a base image,
wherein the base image information include residual data.

12. The multi-view decoding method of claim 11, wherein said up-sampling the base image information includes decoding the base image information, inverse-quantizing the decoded base image information, and transforming the inverse-quantized base image information through inverse discrete cosine transform (IDCT).

13. The multi-view decoding method of claim 11, wherein in said up-sampling the base image information,
the residual data is up-sampled along a movement direction of an image.

14. The multi-view decoding method of claim 11, wherein in said up-sampling the base image information,
the residual data is up-sampled using any one of a horizontal up-sampling mode, a vertical up-sampling mode, and a quarter up-sampling mode.

15. A multi-view video decoder, comprising:
a receiver for receiving a bit stream having base image information and supplementary image information;
an up-sampling unit for up-sampling the base image information; and
a base image generator for performing motion and disparity compensation based on a reference image, the up-sampled base image information, and the supplementary image information, and generating a base image,
wherein the base image information include residual data.

16-18. (canceled)

19. A single-view video encoding method, comprising:
performing motion estimation based on a base image and a reference image;
generating residual data using blocks of the base image and the motion estimated blocks;
down-sampling the residual data; and
transforming the down-sampled residual data through Discrete Cosine Transformation (DCT) and quantizing the transformed residual data.

20. The single-view video encoding method of claim 19, further comprising:
inverse-quantizing the quantized residual data and transforming the inverse-quantized residual data through Inverse Discrete Cosine Transformation (IDCT), and up-sampling the transformed residual data; and
performing motion compensation using the up-sampled residual data and generating a reference image.

21. (canceled)

22. The single-view video encoding method of claim 19, wherein in said down-sampling the residual data,
the residual data is down-sampled along a movement direction of an image.

23. The single-view video encoding method of claim 19, wherein in said down-sampling the residual data,
the residual data is down-sampled using any one of a horizontal down-sampling mode, a vertical down-sampling mode, and a quarter down-sampling mode.

24. A single-view video encoder, comprising:
a motion estimator for performing motion estimation based on a base image and a reference image;
a residual data generator for generating residual data using blocks of the base image and the motion estimated blocks;
a down-sampling unit for down-sampling the residual data; and
a quantizing unit for transforming the down-sampled residual data through Discrete Cosine Transformation (DCT) and quantizing the transformed residual data.

25-28. (canceled)

29. A single-view video decoding method, comprising:
receiving a bit stream including base image information having residual data;
up-sampling the residual data; and
performing motion compensation based on a reference image and the up-sampled residual data and generating a base image.

30. The single-view video decoding method of claim 29, wherein said up-sampling the residual data includes decoding the residual data, inverse-quantizing the decoded residual data, and transforming the inverse-quantized residual data through Inverse Discrete Cosine Transformation (IDCT).

31. The single-view video decoding method of claim 29, wherein in said up-sampling the residual data,
the residual data is up-sampled along a movement direction of an image.

32. The single-view video decoding method of claim 29, wherein in said up-sampling the residual data,
the residual data is up-sampled using any one of a horizontal up-sampling mode, a vertical up-sampling mode, and a quarter up-sampling mode.

33. A single-view video decoder, comprising:
a receiver for receiving a bit stream including base image information having residual data;
an up-sampling unit for up-sampling the residual data; and
a base image generator for performing motion compensation based on a reference image and the up-sampled residual data and generating a base image.

34-36. (canceled)
